(19) United States
(12) Patent Application Publication
(10) Pub. No.: US 2017/0222461 A1
(43) Pub. Date: Aug. 3, 2017

(54) METHOD FOR PERFORMING PERFORMANCE CONTROL IN AN ELECTRONIC DEVICE WITH AID OF MANAGEMENT OF MULTIPLE CHARGER CIRCUITS, AND ASSOCIATED APPARATUS

(71) Applicant: MEDIATEK INC., Hsin-Chu (TW)

(72) Inventor: Nien-Hui Kung, Hsinchu City (TW)

(21) Appl. No.: 15/243,925

(22) Filed: Aug. 22, 2016

Related U.S. Application Data
(60) Provisional application No. 62/288,491, filed on Jan. 29, 2016.

(51) Int. Cl. H02J 7/00; G06F 9/445

(52) U.S. Cl. CPC H02J 7/0052; H02J 7/0029; G06F 9/44505; H02J 2007/006

(57) ABSTRACT

A method for performing performance control in an electronic device with aid of management of multiple charger circuits (e.g. first and second charger circuits) and an associated apparatus are provided. The method includes: applying each of a first set of candidate parameter settings of the first charger circuit to the first charger circuit, and calculating a first score regarding the first charger circuit according to at least one first index of the electronic device; applying each of a second set of candidate parameter settings of the second charger circuit to the second charger circuit, and calculating a second score regarding the second charger circuit according to at least one second index of the electronic device; and optimizing overall performance of the electronic device by applying a first parameter setting to the first charger circuit and by applying a second parameter setting to the second charger circuit.

### CROSS REFERENCE TO RELATED APPLICATIONS

This application claims the benefit of U.S. Provisional Application No. 62/288,491, which was filed on 2016 Jan. 29 and is included herein by reference.

### BACKGROUND

The present invention relates to charger control in a portable electronic device, and more particularly, to a method for performing performance control in an electronic device with aid of management of multiple charger circuits, and an associated apparatus.

According to the related art, an electronic device such as a multifunctional mobile phone may comprise a battery module that provides power, and may further comprise a charging circuit for charging the battery with aid of an external power source of the electronic device. This charging circuit may be designed to merely set its parameter in an initial stage by the input current limitation, in order to prevent the external power source from crashing due to overload during charging the battery. Based on this design, some problems may occur. For example, the charging performance may vary due to temperature variations of the charging circuit or the electronic device. As a result, it is hard to complete charging the battery as soon as possible. Thus, a novel method and associated architecture are required, in order to enhance the overall performance of an electronic device.

### SUMMARY

It is an objective of the claimed invention to provide a method for performing performance control in an electronic device with aid of management of multiple charger circuits, and an associated apparatus, in order to solve the above-mentioned problems.

It is an objective of the claimed invention to provide a method for performing performance control in an electronic device with aid of management of multiple charger circuits, and an associated apparatus, in order to enhance performance control of an electronic device with fewer side effects.

According to at least one preferred embodiment, a method for performing performance control in an electronic device with aid of management of multiple charger circuits is provided, where the charger circuits are positioned in the electronic device and comprise a first charger circuit and a second charger circuit. For example, each of the charger circuits may be an integrated circuit (IC) that comprises a power control circuit. The method may comprise: applying each of a first set of candidate parameter settings of the first charger circuit to the first charger circuit, and calculating a first score regarding the first charger circuit according to at least one first index of the electronic device; applying each of a second set of candidate parameter settings of the second charger circuit to the second charger circuit, and calculating a second score regarding the second charger circuit according to at least one second index of the electronic device; selecting a first parameter setting from the first set of candidate parameter settings according to a set of first scores regarding the first charger circuit, wherein each of the set of first scores corresponds to one of the first set of candidate parameter settings, and the set of first scores comprises the first score; selecting a second parameter setting from the second set of candidate parameter settings according to a set of second scores regarding the second charger circuit, wherein each of the set of second scores corresponds to one of the second set of candidate parameter settings, and the set of second scores comprises the second score; and optimizing overall performance of the electronic device by applying the first parameter setting to the first charger circuit and by applying the second parameter setting to the second charger circuit. In some embodiments, the charger circuits may be charger chips. For example, the first charger circuit may be a first charger chip within the charger chips, and the second charger circuit may be a second charger chip within the charger chips.

According to at least one preferred embodiment, an apparatus for performing performance control in an electronic device with aid of management of multiple charger circuits is provided, where the charger circuits are positioned in the electronic device and comprise a first charger circuit and a second charger circuit, and the apparatus may comprise at least one portion (e.g. a portion or all) of the electronic device. For example, each of the charger circuits may be an IC that comprises a power control circuit. The apparatus may comprise a processing circuit that is positioned in the electronic device. The processing circuit may be arranged for controlling operations of the electronic device. For example, the processing circuit may apply each of a first set of candidate parameter settings of the first charger circuit to the first charger circuit, and may calculate a first score regarding the first charger circuit according to at least one first index of the electronic device. In addition, the processing circuit may apply each of a second set of candidate parameter settings of the second charger circuit to the second charger circuit, and may calculate a second score regarding the second charger circuit according to at least one second index of the electronic device. Additionally, the processing circuit may select a first parameter setting from the first set of candidate parameter settings according to a set of first scores regarding the first charger circuit, and may select a second parameter setting from the second set of candidate parameter settings according to a set of second scores regarding the second charger circuit. Further, the processing circuit may optimize overall performance of the electronic device by applying the first parameter setting to the first charger circuit and by applying the second parameter setting to the second charger circuit, wherein each of the set of first scores corresponds to one of the first set of candidate parameter settings, and the set of first scores comprises the first score, wherein each of the set of second scores corresponds to one of the second set of candidate parameter settings, and the set of second scores comprises the second score. In some embodiments, the charger circuits may be charger chips. For example, the first charger circuit maybe a first charger chip within the charger chips, and the second charger circuit may be a second charger chip within the charger chips.

It is an advantage of the present invention that the present invention method and apparatus can enhance performance control of the electronic device with fewer side effects. As a result of implementing electronic products according to the present invention method and apparatus, the related art problems may no longer be an issue.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing performance control in an electronic device with aid of management of multiple charger circuits according to an embodiment of the present invention.

FIG. 2 illustrates some implementation details of the apparatus shown in FIG. 1 according to an embodiment of the present invention.

FIG. 3 illustrates a working flow of a method for performing performance control in an electronic device with aid of management of multiple charger circuits according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

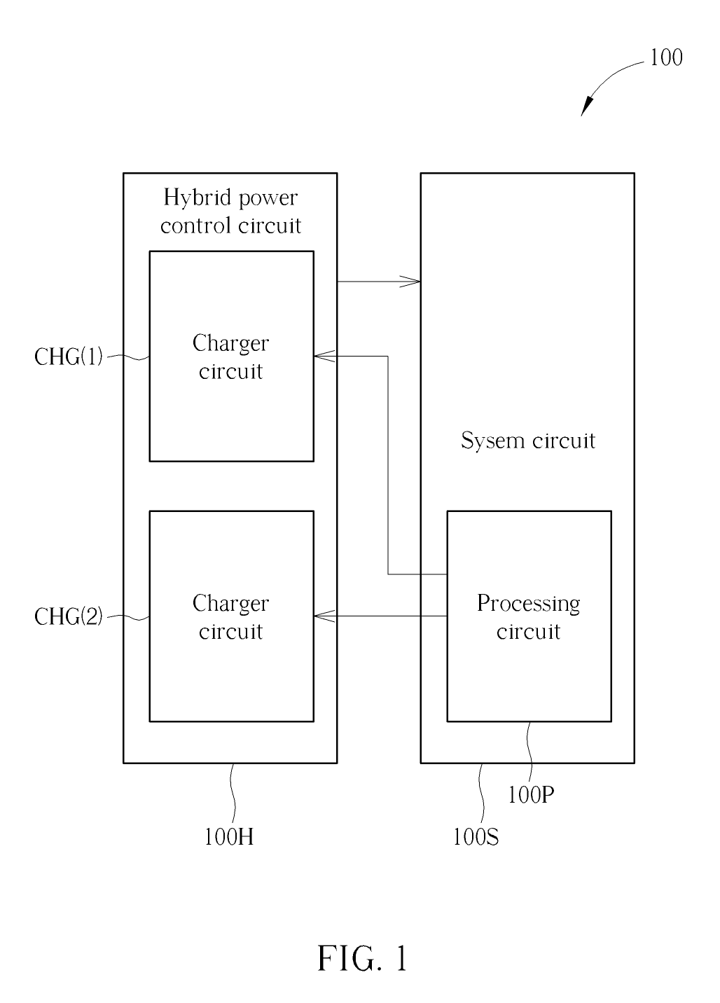

FIG. 1 is a diagram of an apparatus 100 for performing performance control in an electronic device with aid of management of multiple charger circuits according to an embodiment of the present invention, where the apparatus 100 may comprise at least one portion (e.g. a portion or all) of the electronic device. For example, the apparatus 100 may comprise a portion of the electronic device mentioned above, and more particularly, can be at least one hardware circuit such as at least one integrated circuit (IC) within the electronic device and associated circuits thereof. In another example, the apparatus 100 can be the whole of the electronic device mentioned above. In another example, the apparatus 100 may comprise a system comprising the electronic device mentioned above (e.g. a wireless communications system comprising the electronic device). Examples of the electronic device may include, but not limited to, a multifunctional mobile phone, a tablet, and a laptop computer.

The charger circuits mentioned above may be positioned in the electronic device. For example, each of the charger circuits may be an IC that comprises a power control circuit. In another example, at least one portion (e.g. a portion or all) of the charger circuits may be integrated into the same IC. As shown in FIG. 1, the apparatus 100 may comprise a system circuit 100S and a hybrid power control circuit 100H that are positioned in the electronic device in this embodiment, where the system circuit 100S may comprise a processing circuit 100P, and the hybrid power control circuit 100H may comprise the charger circuits. For example, the charger circuits may comprise a first charger circuit such as the charger circuit CHG(1), and may further comprise a second charger circuit such as the charger circuit CHG(2).

According to this embodiment, the system circuit 100S may be a main system circuit of the electronic device, and the processing circuit 100P may be arranged for controlling operations of the electronic device. For example, the processing circuit 100P may comprise at least one processor (e.g. one or more processors) that may run one or more program modules to control the operations of the electronic device. This is for illustrative purposes only, and is not meant to be a limitation of the present invention. According to some embodiments, the processing circuit 100P may be implemented with an application-specific integrated circuit (ASIC). In addition, the hybrid power control circuit 100H may be arranged for performing power control for the electronic device, and the charger circuits therein (e.g. the charger circuit CHG(1) and the charger circuit CHG(2)) may control charging operations regarding a battery of the electronic device, where each of the charger circuits (e.g. the charger circuit CHG(1) or the charger circuit CHG(2)) maybe arranged for selectively charging the battery of the electronic device. For example, the charger circuit CHG (1) may obtain electric power from a first external power source of the electronic device to charge the battery. In another example, the charger circuit CHG(2) may obtain electric power from a second external power source of the electronic device to charge the battery. Additionally, the hybrid power control circuit 100H may perform hybrid power control to provide the system circuit 100S with electric power that may be obtained from the battery or from at least one external power source (e.g. one or more external power sources) of the electronic device, such as the first and the second external power sources. Examples of the aforementioned at least one external power source may include, but not limited to, alternating current (AC)/direct current (DC) adaptors, and DC power sources such as that of Universal Serial Bus (USB) ports of personal computers (PCs).

Based on the architecture shown in FIG. 1, the processing circuit 100P may control the charger circuits such as the charger circuit CHG(1) and the charger circuit CHG(2) when needed. For example, the processing circuit 100P may dynamically change characteristics of at least one portion of the charger circuits (e.g. the charger circuit CHG(1) and/or the charger circuit CHG(2)) at least according to some detection results regarding the electronic device, to complete charging the battery as soon as possible. As a result of taking both of the charging performance (e.g. the charging speed) of the hybrid power control circuit 100H and the system performance of the system circuit 100S into consideration, the processing circuit 100P may optimize the overall performance of the electronic device. According to some embodiments, the processing circuit 100P may operate according to a balance working flow for multi-chargers charging (e.g. dual charging) for the purpose of fast charging with the balance between the charging performance (e.g. the charging speed) and the system performance. For example, the processing circuit 100P may check the charging performance (e.g. the charging speed) and the system performance, and may dynamically adjust the chargers in the hybrid power control circuit 100H (e.g. the charger circuits, such as the charger circuit CHG(1) and the charger circuit CHG(2)).

According to some embodiments, the charger circuits may be charger chips. For example, the first charger circuit may be a first charger chip within the charger chips, and the second charger circuit may be a second charger chip within the charger chips. According to some embodiments, the charger circuits may be implemented to be any of various types of chargers, where examples of the various types of chargers may include, but not limited to, switching type chargers and linear type chargers. For example, one of the charger circuits (e.g. any of the charger circuits CHG (1) and CHG (2)) maybe implemented as a switching type charger, and another of the charger circuits (e.g. the other of the charger circuits CHG(1) and CHG(2)) may be implemented as a linear type charger. In another example, all of the charger circuits (e.g. both of the charger circuits CHG(1) and CHG(2)) may be implemented as switching type chargers. In yet another example, all of the charger circuits (e.g. both of the charger circuits CHG(1) and CHG(2)) may be implemented as linear type chargers.

According to some embodiments, the architecture shown in FIG. 1 may vary. For example, the processing circuit 100P may be integrated into one of the charger circuits, such as one of the charger circuits CHG(1) and CHG(2).

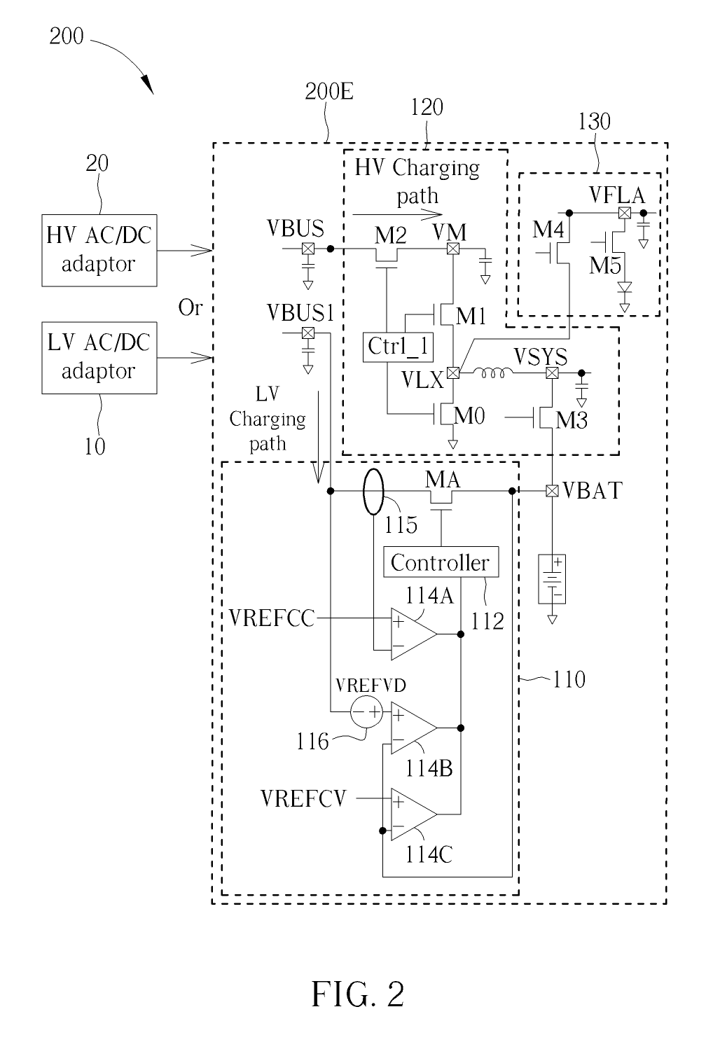

FIG. 2 illustrates some implementation details of the apparatus 100 shown in FIG. 1 according to an embodiment of the present invention. For better comprehension, a portable electronic device 200E (e.g. any of the multifunctional mobile phone, the tablet, and the laptop computer mentioned above) can be taken as an example of the electronic device, and a plurality of adaptors corresponding to different voltages, such as a low voltage (LV) AC/DC adaptor 10 and a high voltage (HV) AC/DC adaptor 20, are also illustrated in the electronic system 200. Please note that the apparatus 100 of this embodiment may comprise at least one portion (e.g. a portion or all) of the portable electronic device 200E. For example, the apparatus 100 of this embodiment may comprise the whole of the portable electronic device 200E. In some examples, the apparatus 100 may comprise only a portion of the portable electronic device 200E, such as internal circuits of the portable electronic device 200E. As shown in FIG. 2, there are multiple terminals VBUS and VBUS1 respectively corresponding to a first charging path (e.g. the HV charging path) and a second charging path (e.g. the LV charging path) in this embodiment. For example, the hybrid power control circuit 100H may comprise some sub-circuits within the portable electronic device 200E, such as the sub-circuits 110, 120, and 130, where the charger circuit CHG(1) may comprise at least one portion (e.g. a portion or all) of the sub-circuit 120, and the charger circuit CHG(2) may comprise at least one portion (e.g. a portion or all) of the sub-circuit 110.

According to this embodiment, the chargers within the portable electronic device 200E, such as the sub-circuits 110 and 120, may be arranged for selectively charging the battery of the electronic device (e.g. the battery shown below the terminal VBAT in FIG. 2), where at least one portion (e.g. a portion or all) of the chargers may be implemented with at least one charger chip (e.g. one or more charger chips), which can be taken as an example of the aforementioned at least one IC. For example, at least one portion (e.g. a portion or all) of the sub-circuit 120 may be implemented as a first charger chip, and at least one portion (e.g. a portion or all) of the sub-circuit 110 may be implemented as a second charger chip, where the first and the second charger chips may be installed at different locations on a printed circuit board (PCB) within the portable electronic device 200E. Preferably, at least one portion (e.g. a portion or all) of the sub-circuit 130 may be integrated into the first charger chip corresponding to the sub-circuit 120. This is for illustrative purposes only, and is not meant to be a limitation of the present invention. According to some embodiments, the sub-circuits 120 and 130 may be implemented with different ICs such as different semiconductor chips. According to some embodiments, the sub-circuits 110, 120, and 130 may be implemented with the same IC such as the same charger chip.

For better comprehension, the pad notation of a square labeled “X” therein can be utilized for representing a pad of an IC, such as an input/output (I/O) pad of the IC. As shown in FIG. 2, the internal circuits of the portable electronic device 200E may comprise multiple terminals (e.g. the terminals VBUS, VBUS1, VM, VLX, VSYS, VFLA, and VBAT), some of which may be pads (or IC pads). For example, the terminal VSYS may be coupled to the system circuit 100S and therefore may be referred to as the system terminal, the terminal VFLA may be coupled to a flash unit (e.g. a light emitting diode (LED) shown around the upper right of FIG. 2) of the electronic device and therefore may be referred to as the flash terminal, and the terminal VBAT may be coupled to the battery and therefore may be referred to as the battery terminal. In addition, the internal circuits of the portable electronic device 200E may comprise a plurality of switching units that may be positioned on the charger chips, respectively, such as the switching units M0, M1, M2, M3, M4, M5, and MA shown in FIG. 2. The internal circuits of the portable electronic device 200E may further comprise a control module that may be coupled to the plurality of switching units and may be arranged for controlling the plurality of switching units. For example, the control module may comprise at least one control circuit (e.g. one or more control circuits) coupled to the plurality of switching units, such as a control circuit Ctrl_1 positioned on the first charger chip and coupled to the switching units M0, M1, M2, M3, M4, and M5 and a controller 112 positioned on the second charger chip and coupled to the switching unit MA. Additionally, the internal circuits of the portable electronic device 200E may further comprise a feedback control circuit, which may be positioned on one of the first and the second charger chips and coupled to the control module. For example, the feedback control circuit may comprise a plurality of monitoring circuits such as the three monitoring circuits 114A, 114B, and 114C, which can be operational transconductance amplifiers (OTAs) in this embodiment, and may further comprise a current detector 115 and a voltage clamping component such as a voltage difference (VD) regulator 116. Examples of the plurality of switching units may include, but not limited to, Metal Oxide Semiconductor Field Effect Transistors (MOSFETs). According to some embodiments, in a situation where at least one portion (e.g. a portion or all) of switching units within the plurality of switching units are implemented with transistors (e.g. Field Effect Transistors (FETs) such as MOSFETs), each switching unit of the aforementioned at least one portion of switching units may be regarded as a switching circuit.

In this embodiments, the terminals VBUS and VBUS1 respectively corresponding to the first and the second charging paths allow the chargers (e.g. the charger circuits mentioned above) to use the LV AC/DC adaptor 10 and the HV AC/DC adaptor 20 independently at the same time, and the control circuit Ctrl_1 may control switching operations of the switching unit MA by instructing the controller 112 when needed. For example, when charging using the second charging path (e.g. the LV charging path) is required, the control circuit Ctrl_1 may allow the controller 112 to turn on the switching unit MA. In another example, when charging using the first charging path (e.g. the HV charging path) is required, the control circuit Ctrl_1 may instruct the controller 112 to turn off the switching unit MA. In another example, when using any of the sub-circuits 120 and 130 is required, the control circuit Ctrl_1 may instruct the controller 112 to turn off the switching unit MA.

Under control of the control module (more particularly, the aforementioned at least one control circuit, which may comprise the control circuit Ctrl_1 and the controller 112 in this embodiment), the charger circuits may provide the battery with the external power obtained through the terminal VBUS1 and provide the system circuit 100S with the external power obtained through the terminal VBUS at the same time when needed. For example, the charger may provide the battery with the external power obtained through the terminal VBUS1 and provide the system circuit 100S and the flash unit (e.g. the LED) with the external power obtained through the terminal VBUS at the same time when needed. In addition, under control of the control module (more particularly, the aforementioned at least one control circuit, which may comprise the control circuit Ctrl_1 and the controller 112 in these embodiment), the charger circuits may provide the battery with both of the external power obtained through the terminal VBUS1 and the external power obtained through the terminal VBUS at the same time to charge the battery when needed. For example, the total charging current may be calculated by at least one of the processing circuit 100P and the control module, and may be shared by the first and the second charging paths according to the associated calculation results under control of the controller 112 (e.g. the controller 112 may control the on resistance of the switching unit MA such as a MOSFET according to the calculation results.

Regarding some details related to the architecture shown in FIG. 2, please refer to U.S. Non-provisional application Ser. No. 15/158,574, which was filed on 2016 May 18 and is included herein by reference.

According to some embodiments, the apparatus 100 shown in FIG. 1, such as at least one portion (e.g. a portion or all) of the portable electronic device 200E shown in FIG. 2, may operate according to a method for performing performance control in the electronic device with aid of management of the multiple charger circuits mentioned above (e.g. the charger circuits CHG(1) and CHG(2)). For example, the processing circuit 100P may apply each of a first set of candidate parameter settings of the first charger circuit (e.g. the charger circuit CHG(1)) to the first charger circuit, and may calculate a first score regarding the first charger circuit according to at least one first index (e.g. one or more first indexes) of the electronic device. In addition, the processing circuit 100P may apply each of a second set of candidate parameter settings of the second charger circuit (e.g. the charger circuit CHG(2)) to the second charger circuit, and may calculate a second score regarding the second charger circuit according to at least one second index (e.g. one or more second indexes) of the electronic device. Additionally, the processing circuit 100P may select a first parameter setting from the first set of candidate parameter settings according to a set of first scores regarding the first charger circuit (e.g. the charger circuit CHG(1)), and may select a second parameter setting from the second set of candidate parameter settings according to a set of second scores regarding the second charger circuit (e.g. the charger circuit CHG(2)). Further, the processing circuit 100P may optimize the overall performance of the electronic device by applying the first parameter setting to the first charger circuit (e.g. the charger circuit CHG(1)) and by applying the second parameter setting to the second charger circuit (e.g. the charger circuit CHG(2)). For example, each of the set of first scores may correspond to one of the first set of candidate parameter settings, and the set of first scores may comprise the first score. In addition, each of the set of second scores may correspond to one of the second set of candidate parameter settings, and the set of second scores may comprise the second score.

As a result of implementing electronic products according to the present invention method (e.g. the aforementioned method for performing performance control in the electronic device with aid of management of the multiple charger circuits) and the associated apparatus (e.g. the apparatus 100, or at least one processing circuit (such as the processing circuit 100P, positioned in the electronic device) for performing performance control according to the above method), performance control of the electronic products can be enhanced. For example, the apparatus 100 may complete charging the battery as soon as possible, and may maintain the balance between the charging performance (e.g. the charging speed) and the system performance. In some embodiments, the charging performance (e.g. the charging speed) may be enhanced while the system performance will not be degraded.

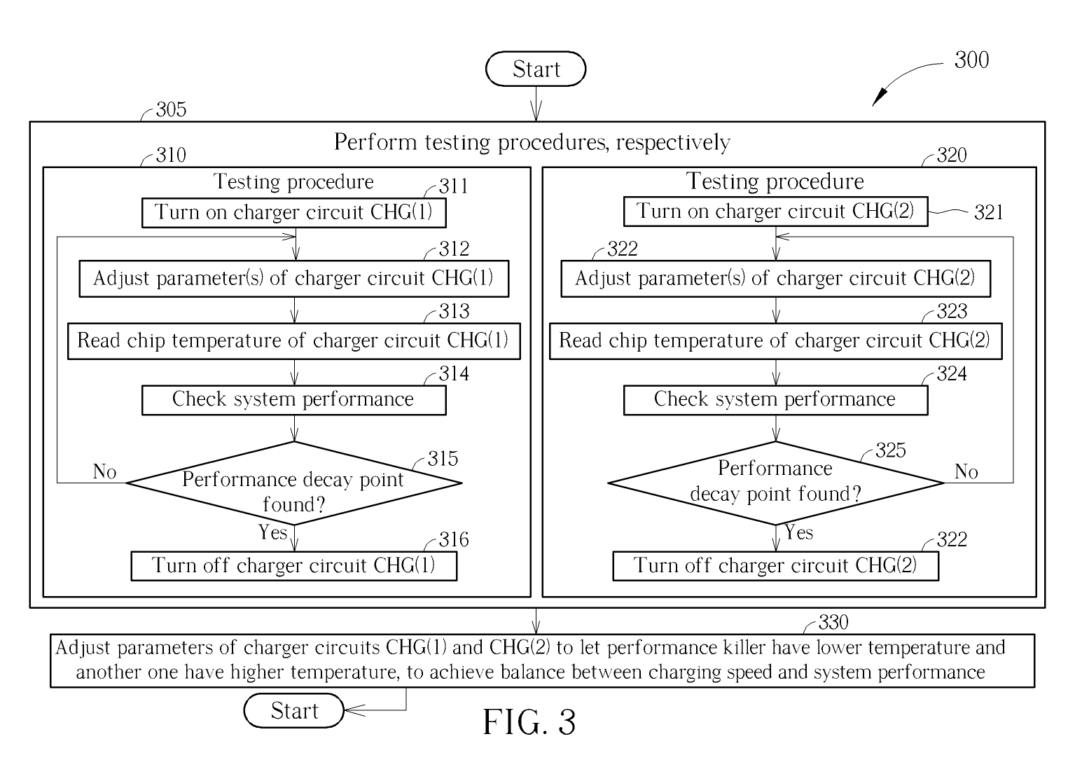

FIG. 3 illustrates a working flow 300 of the aforementioned method for performing performance control in the electronic device with aid of management of the multiple charger circuits according to an embodiment of the present invention. The method can be applied to the apparatus 100 shown in FIG. 1, such as at least one portion (e.g. a portion or all) of the portable electronic device 200E shown in FIG. 2, and more particularly, can be applied to the processing circuit 100P.

In Step 305, the processing circuit 100P may perform testing procedures 310 and 320, respectively. For example, the processing circuit 100P may control the electronic device to operate according to the testing procedure 310 and then operate according to the testing procedure 320. In another example, the processing circuit 100P may control the electronic device to operate according to the testing procedure 320 and then operate according to the testing procedure 310.

Regarding the testing procedure 310, the processing circuit 100P may control the electronic device to perform operations of Step 311 through to Step 316.

In Step 311, the processing circuit 100P may turn on the charger circuit CHG(1).

In Step 312, the processing circuit 100P may adjust parameter(s) of the charger circuit CHG(1). The operation of adjusting the parameter(s) of the charger circuit CHG(1) can be taken as an example of the operation of applying each of the first set of candidate parameter settings of the first charger circuit (e.g. the charger circuit CHG(1)) to the first charger circuit.

In Step 313, the processing circuit 100P may read the chip temperature of the charger circuit CHG(1). For example, the processing circuit 100P may obtain and record the chip temperature of the charger circuit CHG(1) at this moment, where the chip temperature of the charger circuit CHG(1) can be taken as an example of the aforementioned at least one first index.

In Step 314, the processing circuit 100P may check the system performance. For example, the processing circuit 100P may obtain and record one or more index values related to the system performance at this moment by detection or by calculation, where the one or more index values can be taken as an example of the aforementioned at least one first index.

In Step 315, the processing circuit 100P may check whether a performance decay point of the system performance (in the testing procedure 310) is found. According to this embodiment, the performance decay point in the testing procedure 310 may correspond to an extreme value regarding the system performance. When this performance decay point of the system performance is found, Step 316 is entered; otherwise, Step 312 is entered.

For example, operations in the loop comprising Step 312 through to Step 315 may be performed repeatedly and the processing circuit 100P may record a series of data points regarding the system performance. In addition, the way of adjusting the parameter(s) of the charger circuit CHG(1) may be designed to cause the series of data points to correspond to a specific trend (e.g. an increasing or a non-dropping curve in an early stage of adjusting the parameter(s) of the charger circuit CHG(1)). For example, the parameter(s) of the charger circuit CHG(1) may comprise an input current limitation value of the charger circuit CHG(1), and during the adjustment of the input current limitation value in this loop, the input current limitation value may start from a small value and may be adjusted to increase gradually. When a latest data point indicates that the system performance start to become lower, the data point that is just obtained before the latest data point may represent the maximum of the series of data points, and may be regarded as the performance decay point in the testing procedure 310.

In Step 316, the processing circuit 100P may turn off the charger circuit CHG(1).

Regarding the testing procedure 320, the processing circuit 100P may control the electronic device to perform operations of Step 321 through to Step 326.

In Step 321, the processing circuit 100P may turn on the charger circuit CHG(2).

In Step 322, the processing circuit 100P may adjust parameter(s) of the charger circuit CHG(2). The operation of adjusting the parameter(s) of the charger circuit CHG(2) can be taken as an example of the operation of applying each of the second set of candidate parameter settings of the second charger circuit (e.g. the charger circuit CHG(2)) to the second charger circuit.

In Step 323, the processing circuit 100P may read the chip temperature of the charger circuit CHG(2). For example, the processing circuit 100P may obtain and record the chip temperature of the charger circuit CHG(2) at this moment, where the chip temperature of the charger circuit CHG(2) can be taken as an example of the aforementioned at least one second index.

In Step 324, the processing circuit 100P may check the system performance. For example, the processing circuit 100P may obtain and record one or more index values related to the system performance at this moment by detection or by calculation, where the one or more index values can be taken as an example of the aforementioned at least one second index.

In Step 325, the processing circuit 100P may check whether a performance decay point of the system performance (in the testing procedure 320) is found. According to this embodiment, the performance decay point in the testing procedure 320 may correspond to an extreme value regarding the system performance. When this performance decay point of the system performance is found, Step 326 is entered; otherwise, Step 322 is entered.

For example, operations in the loop comprising Step 322 through to Step 325 may be performed repeatedly and the processing circuit 100P may record a series of data points regarding the system performance. In addition, the way of adjusting the parameter(s) of the charger circuit CHG(2) may be designed to cause the series of data points to correspond to a specific trend (e.g. an increasing or a non-dropping curve in an early stage of adjusting the parameter(s) of the charger circuit CHG(2)). For example, the parameter(s) of the charger circuit CHG(2) may comprise an input current limitation value of the charger circuit CHG(2), and during the adjustment of the input current limitation value in this loop, the input current limitation value may start from a small value and may be adjusted to increase gradually. When a latest data point indicates that the system performance start to become lower, the data point that is just obtained before the latest data point may represent the maximum of the series of data points, and may be regarded as the performance decay point in the testing procedure 320.

In Step 326, the processing circuit 100P may turn off the charger circuit CHG(2).

In Step 330, the processing circuit 100P may adjust the parameters of the charger circuits CHG(1) and CHG(2) to let the performance killer (e.g. one of the charger circuits CHG(1) and CHG(2), such as that degrades the system performance more severely based on the test results of the testing procedures 310 and 320) have lower temperature and another one (e.g. the other of the charger circuits CHG(1) and CHG (2)) have higher temperature, to achieve balance between the charging speed and the system performance.

According to some embodiments, the working flow 300 may be changed when needed. For example, one or more steps in each of the testing procedures 310 and 320 may be omitted. In some examples, one or more steps may be added or inserted into each of the testing procedures 310 and 320.

According to some embodiments, the processing circuit 100P may calculate some scores in the testing procedures 310 and 320, where these scores may be taken as an example of the test results of the testing procedures 310 and 320. For example, the processing circuit 100P may turn off both of the charger circuits CHG(1) and CHG(2), and the processing circuit 100P may determine that the score of the system performance is 100 in this situation. In addition, the processing circuit 100P may turn on the charger circuit CHG(1) and may determine (e.g. by calculation) the scores of the system performance that correspond to different parameter settings of the charger circuit CHG(1), respectively, where the processing circuit 100P may keep the charger circuit CHG(2) at a fixed state thereof, such as a turn off state (e.g. the charger circuit CHG(2) is turned off) or a fixed-setting state (e.g. the charger circuit CHG(2) may be turned on, but the parameter setting thereof is fixed and is not changed). For example, when the charger circuit CHG(2) is in the fixed state thereof, the processing circuit 100P may turn on the charger circuit CHG(1) with a parameter setting A1, and may determine (e.g. by calculation) that the score of the system performance is 90. When the charger circuit CHG(2) is in the fixed state thereof, the processing circuit 100P may turn on the charger circuit CHG(1) with a parameter setting B1, and may determine (e.g. by calculation) that the score of the system performance is 80. When the charger circuit CHG(2) is in the fixed state thereof, the processing circuit 100P may turn on the charger circuit CHG(1) with a parameter setting C1, and may determine (e.g. by calculation) that the score of the system performance is 70. Additionally, the processing circuit 100P may turn on the charger circuit CHG(2) and may determine (e.g. by calculation) the scores of the system performance that correspond to different parameter settings of the charger circuit CHG(2), respectively, where the processing circuit 100P may keep the charger circuit CHG(1) at a fixed state thereof, such as a turn off state (e.g. the charger circuit CHG(1) is turned off) or a fixed-setting state (e.g. the charger circuit CHG(1) may be turned on, but the parameter setting thereof is fixed and is not changed). For example, when the charger circuit CHG(1) is in the fixed state thereof, the processing circuit 100P may turn on the charger circuit CHG(2) with a parameter setting A2, and may determine (e.g. by calculation) that the score of the system performance is 95. When the charger circuit CHG(1) is in the fixed state thereof, the processing circuit 100P may turn on the charger circuit CHG(2) with a parameter setting B2, and may determine (e.g. by calculation) that the score of the system performance is 90. When the charger circuit CHG(1) is in the fixed state thereof, the processing circuit 100P may turn on the charger circuit CHG(2) with a parameter setting C2, and may determine (e.g. by calculation) that the score of the system performance is 85. Further, after obtaining the scores described above, in order to achieve the score of 85 regarding the system performance while trying to achieve the balance between the charging performance (e.g. the charging speed) and the system performance, the processing circuit 100P may choose the parameter setting A1 for the charger circuit CHG(1) and choose the parameter setting B2 for the charger circuit CHG(2), and may turn on the charger circuit CHG(1) with the parameter setting A1 and turn on the charger circuit CHG(2) with the parameter setting B2, to optimize the overall performance of the electronic device. In some embodiments, the high score is, the high performance is.

According to some embodiments, the scores that the processing circuit 100P calculates in the testing procedures 310 and 320 may comprise charging performance scores, such as scores of the charging performance that correspond to some parameter settings, respectively. In these embodiments, the parameter settings A1 and A2 may be equivalent to each other and therefore may be regarded as the parameter setting A, the parameter settings B1 and B2 maybe equivalent to each other and therefore may be regarded as the parameter setting B, and the parameter settings C1 and C2 may be equivalent to each other and therefore may be regarded as the parameter setting C. For example, a score of the charging performance that correspond to the parameter setting A plus a score of the charging performance that correspond to the parameter setting B is greater than a score of the charging performance that correspond to the parameter setting C. In order to achieve the score of 85 regarding the system performance while trying to achieve the balance between the charging performance (e.g. the charging speed) and the system performance, the processing circuit 100P may choose the parameter setting A for the charger circuit CHG(1) and choose the parameter setting B for the charger circuit CHG(2), and may turn on the charger circuit CHG(1) with the parameter setting A and turn on the charger circuit CHG(2) with the parameter setting B, to optimize the overall performance of the electronic device. According to some embodiments, for different system user scenarios, the processing circuit 100P may adjust the parameter settings of the charger circuits CHG(1) and CHG(2) by different system performance requirement.

According to some embodiments, at least one portion (e.g. a portion or all) of the scores maybe related to the system performance. More particularly, the aforementioned at least one first index may comprise at least one system performance index of the system circuit 100S (e.g. the main system circuit within the electronic device), and the aforementioned at least one second index may also comprise the aforementioned at least one system performance index, where the processing circuit 100P may comprise at least one portion of the main system circuit, such as one or more processors on the main system circuit, and the set of first scores and the set of second scores may be related to the system performance of the main system circuit. For example, the aforementioned at least one system performance index may comprise one or a combination of a central processing unit (CPU) speed of a CPU within the main system circuit, a CPU power loss of the CPU, a graphics processing unit (GPU) speed of a GPU within the main system circuit, and a GPU power loss of the GPU. In some embodiments, the set of first scores and the set of second scores are system performance scores of the main system circuit.

According to some embodiments, while a portion of the scores may be related to the system performance, another portions of the scores may be related to the charger circuit temperature of any of the charger circuits (e.g. the charger circuits CHG(1) and CHG(2)), such as the charger chip temperature of any of the charger chips. More particularly, the aforementioned at least one first index may further comprise a chip temperature index of the charger circuit CHG(1), and the aforementioned at least one second index may further comprise a chip temperature index of the charger circuit CHG(2). In addition, the set of first scores may be further related to chip temperature measurement results of the charger circuit CHG(1), and the set of second scores may be further related to chip temperature measurement results of the charger circuit CHG(2). For example, the first score may be a hybrid score related to both of a first system performance score of the main system circuit and a first charger circuit temperature score of the charger circuit CHG(1), and the second score maybe a hybrid score related to both of a second system performance score of the main system circuit and a second charger circuit temperature score of the charger circuit CHG(2). In some embodiments, the first score maybe a linear combination of the first system performance score and the first charger circuit temperature score, and the second score maybe a linear combination of the second system performance score and the second charger circuit temperature score.

According to some embodiments, at least one portion (e.g. a portion or all) of the scores may be related to the charger circuit temperature of any of the charger circuits (e.g. the charger circuits CHG(1) and CHG(2)), such as the charger chip temperature of any of the charger chips. More particularly, the aforementioned at least one first index may comprise a chip temperature index of the charger circuit CHG(1), and the aforementioned at least one second index may comprise a chip temperature index of the charger circuit CHG(2). In addition, the set of first scores may be related to chip temperature measurement results of the charger circuit CHG(1), and the set of second scores may be related to chip temperature measurement results of the charger circuit CHG(2). For example, the set of first scores may be charger circuit temperature scores of the charger circuit CHG(1), and the set of second scores maybe charger circuit temperature scores of the charger circuit CHG(2).

According to some embodiments, each of the first set of candidate parameter settings may be a predetermined setting of at least one first parameter of the charger circuit CHG(1), and each of the second set of candidate parameter settings may be a predetermined setting of at least one second parameter of the charger circuit CHG(2). For example, the aforementioned at least one first parameter may comprise a charging current of the charger circuit CHG(1), and the aforementioned at least one second parameter may comprise a charging current of the charger circuit CHG(2). In one of these embodiment, the aforementioned at least one first parameter may comprise at least one reference voltage Vref(1) of at least one error amplifier (EA) of at least one feedback control loop within the charger circuit CHG(1), and the aforementioned at least one second parameter may comprise at least one reference voltage Vref(2) of at least one EA of at least one feedback control loop within the charger circuit CHG(2). Examples of these EAs may include, but not limited to, monitoring circuits such as the OTAs. In another of these embodiment, the aforementioned at least one first parameter may comprise at least one reference current Iref(1) of at least one EA of at least one feedback control loop within the charger circuit CHG(1), and the aforementioned at least one second parameter may comprise at least one reference current Iref(2) of at least one EA of at least one feedback control loop within the charger circuit CHG(2). Examples of these EAs may include, but not limited to, monitoring circuits such as the OTAs. In yet another of these embodiment, the aforementioned at least one first parameter may comprise one or a combination of an Automatic Input Current Limit (AICL) parameter of the charger circuit CHG(1) and an Input Voltage Dynamic Power Management (VIN-DPM) parameter of the charger circuit CHG(1), and the aforementioned at least one second parameter may comprise one or a combination of an AICL parameter of the charger circuit CHG(2) and a VIN-DPM parameter of the charger circuit CHG(2).

According to some embodiments, during quick charging, the processing circuit 100P may set the charging current as a key parameter. For example, the processing circuit 100P may also set AICL or VINDPM to achieve high charging current with low die temperature (or with high efficiency).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing performance control in an electronic device with aid of management of multiple charger circuits, the charger circuits being positioned in the electronic device and comprising a first charger circuit and a second charger circuit, the method comprising:
applying each of a first set of candidate parameter settings of the first charger circuit to the first charger circuit, and calculating a first score regarding the first charger circuit according to at least one first index of the electronic device;
applying each of a second set of candidate parameter settings of the second charger circuit to the second charger circuit, and calculating a second score regarding the second charger circuit according to at least one second index of the electronic device;
selecting a first parameter setting from the first set of candidate parameter settings according to a set of first scores regarding the first charger circuit, wherein each of the set of first scores corresponds to one of the first set of candidate parameter settings, and the set of first scores comprises the first score;
selecting a second parameter setting from the second set of candidate parameter settings according to a set of second scores regarding the second charger circuit, wherein each of the set of second scores corresponds to one of the second set of candidate parameter settings, and the set of second scores comprises the second score; and
optimizing overall performance of the electronic device by applying the first parameter setting to the first charger circuit and by applying the second parameter setting to the second charger circuit.

2. The method of claim 1, wherein the at least one first index comprises at least one system performance index of a main system circuit within the electronic device, and the at least one second index comprises the at least one system performance index; and the set of first scores and the set of second scores are related to system performance of the main system circuit.

3. The method of claim 2, wherein the at least one system performance index comprises one or a combination of a central processing unit (CPU) speed of a CPU within the main system circuit, a CPU power loss of the CPU, a graphics processing unit (GPU) speed of a GPU within the main system circuit, and a GPU power loss of the GPU.

4. The method of claim 2, wherein the set of first scores and the set of second scores are system performance scores of the main system circuit.

5. The method of claim 2, wherein the at least one first index further comprises a chip temperature index of the first charger circuit, and the at least one second index further comprises a chip temperature index of the second charger circuit; and the set of first scores are further related to chip temperature measurement results of the first charger circuit, and the set of second scores are further related to chip temperature measurement results of the second charger circuit.

6. The method of claim 5, wherein the first score is a hybrid score related to both of a first system performance score of the main system circuit and a first charger circuit temperature score of the first charger circuit, and the second score is a hybrid score related to both of a second system performance score of the main system circuit and a second charger circuit temperature score of the second charger circuit.

7. The method of claim 6, wherein the first score is a linear combination of the first system performance score and the first charger circuit temperature score; and the second score is a linear combination of the second system performance score and the second charger circuit temperature score.

8. The method of claim 1, wherein the at least one first index comprises a chip temperature index of the first charger circuit, and the at least one second index comprises a chip temperature index of the second charger circuit; and the set of first scores are related to chip temperature measurement results of the first charger circuit, and the set of second scores are related to chip temperature measurement results of the second charger circuit.

9. The method of claim 8, wherein the set of first scores are charger circuit temperature scores of the first charger circuit; and the set of second scores are charger circuit temperature scores of the second charger circuit.

10. The method of claim 1, wherein each of the first set of candidate parameter settings is a predetermined setting of at least one first parameter of the first charger circuit, and each of the second set of candidate parameter settings is a predetermined setting of at least one second parameter of the second charger circuit.

11. The method of claim 10, wherein the at least one first parameter comprises a charging current of the first charger circuit; and the at least one second parameter comprises a charging current of the second charger circuit.

12. The method of claim 10, wherein the at least one first parameter comprises at least one reference voltage of at least one error amplifier (EA) of at least one feedback control loop within the first charger circuit; and the at least one second parameter comprises at least one reference voltage of at least one EA of at least one feedback control loop within the second charger circuit.

13. The method of claim 10, wherein the at least one first parameter comprises at least one reference current of at least one error amplifier (EA) of at least one feedback control loop within the first charger circuit; and the at least one second parameter comprises at least one reference current of at least one EA of at least one feedback control loop within the second charger circuit.

14. The method of claim 10, wherein the at least one first parameter comprises one or a combination of an Automatic Input Current Limit (AICL) parameter of the first charger circuit and an Input Voltage Dynamic Power Management (VIN-DPM) parameter of the first charger circuit; and the at least one second parameter comprises one or a combination of an AICL parameter of the second charger circuit and a VIN-DPM parameter of the second charger circuit.

15. A processing circuit for performing performance control according to the method of claim 1, wherein the processing circuit is positioned in the electronic device.

16. An apparatus for performing performance control in an electronic device with aid of management of multiple charger circuits, the charger circuits being positioned in the electronic device and comprising a first charger circuit and a second charger circuit, the apparatus comprising:
a processing circuit, positioned in the electronic device, arranged for controlling operations of the electronic device, wherein the processing circuit applies each of a first set of candidate parameter settings of the first charger circuit to the first charger circuit, and
calculates a first score regarding the first charger circuit according to at least one first index of the electronic device, the processing circuit applies each of a second set of candidate parameter settings of the second charger circuit to the second charger circuit, and calculates a second score regarding the second charger circuit according to at least one second index of the electronic device, the processing circuit selects a first parameter setting from the first set of candidate parameter settings according to a set of first scores regarding the first charger circuit, and selects a second parameter setting from the second set of candidate parameter settings according to a set of second scores regarding the second charger circuit, and the processing circuit optimizes overall performance of the electronic device by applying the first parameter setting to the first charger circuit and by applying the second parameter setting to the second charger circuit, wherein each of the set of first scores corresponds to one of the first set of candidate parameter settings, and the set of first scores comprises the first score, wherein each of the set of second scores corresponds to one of the second set of candidate parameter settings, and the set of second scores comprises the second score.

17. The apparatus of claim 16, wherein the at least one first index comprises at least one system performance index of a main system circuit within the electronic device, and the at least one second index comprises the at least one system performance index, wherein the processing circuit comprises at least one portion of the main system circuit; and the set of first scores and the set of second scores are related to system performance of the main system circuit.

18. The apparatus of claim 17, wherein the at least one system performance index comprises one or a combination of a central processing unit (CPU) speed of a CPU within the main system circuit, a CPU power loss of the CPU, a graphics processing unit (GPU) speed of a GPU within the main system circuit, and a GPU power loss of the GPU.

19. The apparatus of claim 16, wherein the at least one first index comprises a chip temperature index of the first charger circuit, and the at least one second index comprises a chip temperature index of the second charger circuit; and the set of first scores are related to chip temperature measurement results of the first charger circuit, and the set of second scores are related to chip temperature measurement results of the second charger circuit.

20. The apparatus of claim 16, wherein the processing circuit is integrated into one of the charger circuits.
